(19) United States
(12) Patent Application Publication
(10) Pub. No.: US 2010/0017817 A1
(43) Pub. Date: Jan. 21, 2010

(54) METHOD FOR INSERTING ADVERTISEMENTS INTO A TRAFFIC CAMERA IMAGE

(75) Inventors: Nathan J. Harrington, Cary, NC (US); Harry L. Hoots, III, Raleigh, NC (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/173,417

(22) Filed: Jul. 15, 2008

(51) Int. Cl. H04N 7/00

(52) U.S. Cl. 725/32

(57) ABSTRACT

The present disclosure describes a method for inserting advertisements into a traffic camera image. The method may receive an advertisement package, the advertisement package comprising a business identifier, a message text, and a price per congestion level. The method may store the advertisement package. The method may receive a user query for a traffic camera image. The method may receive the traffic camera image, the traffic camera image comprising a camera image, a business indicator, and coordinates of the traffic camera image. The method may associate the traffic camera image with the advertisement package. The method may then produce an overlay image associated with the advertisement package. The method may merge the traffic camera image and the overlay image into a final image. Finally, the method may display the final image.

### TECHNICAL FIELD

The present disclosure generally relates to the field of traffic cameras, and more particularly to a method for inserting advertisements into a traffic camera image.

### BACKGROUND

Modern advertisement displays found in websites that display traffic camera images generally do not take into account the condition of the traffic that the traffic camera image is displaying. For example, a website may display a traffic camera image with an advertisement; however, the advertisement may be unrelated to any of the businesses that are viewable within the traffic camera image.

Previously, prior art disclosed providing keyword based advertisements based upon the name of the street the camera is focused on. For example, a website may show advertisements for ‘Harrison Electronics’ if the current traffic camera image displays ‘Harrison Avenue’, even though ‘Harrison Electronics’ is in a geographical area not covered by the traffic camera's image.

### SUMMARY

The present disclosure describes a method for inserting advertisements into a traffic camera image. The method may receive an advertisement package, the advertisement package comprising a business identifier, a message text, and a price per congestion level. The method may store the advertisement package. The method may receive a user query for a traffic camera image. The method may receive the traffic camera image, the traffic camera image comprising a camera image, a business indicator, and coordinates of the traffic camera image. The method may associate the traffic camera image with the advertisement package. The method may then produce an overlay image associated with the advertisement package. The method may merge the traffic camera image and the overlay image into a final image. Finally, the method may display the final image.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram depicting a method for inserting advertisements into a traffic camera image.

### DETAILED DESCRIPTION

Reference will now be made in detail to the subject matter disclosed, which is illustrated in the accompanying drawings.

The present disclosure describes a method for inserting advertisements into a traffic camera image. The method may receive an advertisement package, the advertisement package comprising a business identifier, a message text, and a price per congestion level. The method may store the advertisement package. The method may receive a user query for a traffic camera image. The method may receive the traffic camera image, the traffic camera image comprising a camera image, a business indicator, and coordinates of the traffic camera image. The method may associate the traffic camera image with the advertisement package. The method may then produce an overlay image associated with the advertisement package. The method may merge the traffic camera image and the overlay image into a final image. Finally, the method may display the final image.

One possible embodiment of the present disclosure describes a method for owners of businesses viewable within the traffic camera image to provide traffic volume related advertisements with indicators of the business's position on the traffic camera image.

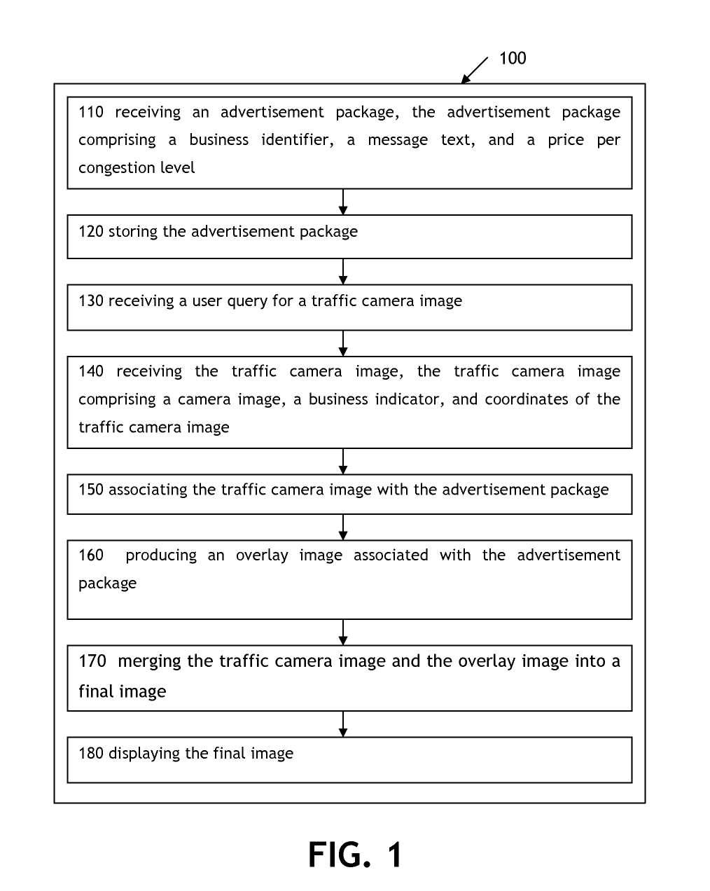

Referring to FIG. 1, a flow diagram for a method for inserting an advertisement into a traffic camera image is depicted 100. The method 100 may receive an advertisement package, the advertisement package comprising a business identifier, a message text, and a price per congestion level 110. The method 100 may store the advertisement package 120. The method 100 may receive a user query for a traffic camera image 130. The method 100 may receive the traffic camera image, the traffic camera image comprising a camera image, a business indicator, and coordinates of the traffic camera image 140. The method 100 may associate the traffic camera image with the advertisement package 150. The method 100 may then produce an overlay image associated with the advertisement package 160. The method 100 may merge the traffic camera image and the overlay image into a final image 170. Finally, the method 100 may display the final image 180.

For example, a business owner or advertiser may enter a range of available prices for a product or service depending upon traffic conditions. The method 100 may query a traffic volume database and select an ad to display based upon the amount of traffic congestion. If there is a high degree of nearby traffic congestion, the method 100 may display a “high traffic volume” message, which may include extra discounts on products or services to entice people to come to the business owner's store.

The method 100 may use a Services Oriented Architecture set of interfaces to connect advertisers or business owners with viewers of traffic camera images through a Services Orientated Architecture set of interfaces.

The traffic camera image 130 may comprise of a camera image, a business indicator, and a set of coordinates that indicate where a point of interest is in a specified camera image. For example, a user may query for a traffic camera image of a particular street. The camera image may be a streaming image or a still image of the particular street. The business indicator may comprise a visual depiction that indicates a particular business that is viewable within the traffic camera image. The visual depiction may comprise a text box with the business's name or the like. The coordinates may comprise an (x,y) location of the business within the traffic camera image.

The method 100 may receive an advertisement package. The advertisement package may comprise a business identifier, which may identify the name of the business; a message text, which may comprise a message a business owner or an advertiser wants to be displayed; and a price per congestion level, which may comprise the price to display at a predefined level of traffic congestion. The business owner or advertiser may set the predefined level of traffic congestion.

Upon receiving an advertisement package and a user query for a traffic camera image, the method 100 may associate the traffic camera image with the advertisement package. Associating the traffic camera image with the advertisement package may comprise aligning a specified business identified in the advertisement package with the corresponding traffic camera image 150.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A computer program product for inserting advertisements into a traffic camera image, comprising:
a tangible computer useable medium having computer useable code tangibly embodied therewith, the computer useable program code comprising:
computer program code configured to receive an advertisement package, the advertisement package comprising a business identifier, a message text, and a price per congestion level;
computer program code configured to receive a high traffic advertisement;
computer program code configured to store the advertisement package and the high traffic advertisement;
computer program code configured to receive a user query for the traffic camera image;
computer program code configured to receive the traffic camera image, the traffic camera image comprising a camera image, a business indicator, and coordinates of the traffic camera image;
computer program code configured to query a traffic volume database;
computer program code configured to receive a traffic congestion level from the traffic volume database;
computer program code configured to associate the traffic camera image with the advertisement package;
computer program code configured to produce an overlay image associated with the advertisement package;
computer program code configured to merge the traffic camera image and the overlay image into a final image; and
computer program code configured to display the final image and the high traffic advertisement, wherein the high traffic advertisement is displayed when the traffic congestion level is high.
